(19) United States
(12) Patent Application Publication
(10) Pub. No.: US 2021/0071511 A1
(43) Pub. Date: Mar. 11, 2021

(54) DOWNHOLE CENTRIFUGAL PUMP HAVING NON-CIRCULAR SHAFT

(71) Applicant: Halliburton Energy Services, Inc., Houston, TX (US)

(72) Inventors: Joshua Wayne WEBSTER, Sand Springs, OK (US); Wesley John NOWITZKI, Tulsa, OK (US); Steven Andrew LOVELL, Tulsa, OK (US); Matthew Thomas KING, Tulsa, OK (US)

(21) Appl. No.: 17/052,787

(22) PCT Filed: Jun. 26, 2019
(86) PCT No.: PCT/US2019/039339

§ 371 Date: Nov. 3, 2020

Related U.S. Application Data
(60) Provisional application No. 62/714,536, filed on Aug. 3, 2018.

(51) Int. Cl. E21B 43/12; F04D 13/10

(52) U.S. Cl. CPC E21B 43/128; F04D 29/20; F04D 13/10

(57) ABSTRACT

A downhole centrifugal pump includes a motor, and impeller, and a shaft having a longitudinal axis and a non-circular cross section in a plane perpendicular to the longitudinal axis. The shaft is connected to the motor and the impeller such that rotational power provided by the motor to the shaft is provided to the impeller.

### CROSS SECTION TO RELATED APPLICATION

This application claims the benefit of and priority to U.S. Provisional Application No. 62/714,536, filed Aug. 3, 2018, which is hereby incorporated by reference.

### BACKGROUND

The present disclosure relates generally to a centrifugal pump used within a subterranean well or at a surface of the well, and more specifically to systems, apparatuses and methods employing a keyless coupling between a driven shaft and an impeller of the pump.

Downhole centrifugal pumps are typically motor driven such that the motor imparts a rotational force to a circular shaft. The shaft is typically provided with a notch, slot or keyway that is cut or formed into the surface of the shaft. A similar keyway may be provided in a body or hub of the impeller. A key or other fastener may be placed in the keyway of the shaft and the keyway of the impeller to transmit power between the shaft and the impeller. While this coupling method is a common and inexpensive way of providing power transmission, the notch or keyway provided in the shaft can provide an area of increased stress concentration which may result in premature failure of the shaft. Other common failure modes occur when the impeller or other components such as bearings or spacers positioned along the shaft are made of harder materials than the key positioned in the keyways. An example of this includes the use of tungsten carbide bearings along the shaft between impellers. When keys are made from softer materials, such as a nickel alloy, the keys may be worn prematurely resulting in the shaft no longer transmitting power to the component engaged by the key.

### BRIEF DESCRIPTION OF THE DRAWINGS

FIG. 1 illustrates a schematic view of a wellbore pump system according to an illustrative embodiment;

FIG. 2 illustrates a cross-sectional schematic view of a multi-stage downhole centrifugal pump according to an illustrative embodiment;

FIG. 3 illustrates an isometric view of an impeller and shaft of the pump of FIG. 2;

FIG. 4 illustrates a front view of the impeller and shaft of FIG. 3;

FIG. 5 illustrates a cross-sectional view of a shaft having a polygonal profile according to an illustrative embodiment; and

FIG. 6 illustrates a cross-sectional view of a shaft having a polygonal profile according to an illustrative embodiment.

### DETAILED DESCRIPTION

In the following detailed description of several illustrative embodiments, reference is made to the accompanying drawings that form a part hereof. These embodiments are described in sufficient detail to enable those skilled in the art to practice the disclosed subject matter, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

As used herein, the phrases “hydraulically coupled,” “hydraulically connected,” “in hydraulic communication,” “fluidly coupled,” “fluidly connected,” and “in fluid communication” refer to a form of coupling, connection, or communication related to fluids, and the corresponding flows or pressures associated with these fluids. In some embodiments, a hydraulic coupling, connection, or communication between two components describes components that are associated in such a way that fluid pressure may be transmitted between or among the components. Reference to a fluid coupling, connection, or communication between two components describes components that are associated in such a way that a fluid can flow between or among the components. Hydraulically coupled, connected, or communicating components may include certain arrangements where fluid does not flow between the components, but fluid pressure may nonetheless be transmitted such as via a diaphragm or piston or other means of converting applied flow or pressure to mechanical or fluid force.

The present disclosure relates to a centrifugal pump that includes a motor and an impeller that is driven by the motor. Connecting the motor and impeller is a shaft having a non-circular cross-section that is received by a complimentary bore on the impeller that also has a non-circular cross-section. The mating engagement of the shaft and the impeller allows for the elimination of a key or other fastener-related coupling that is typically used to couple a traditional impeller and shaft. Since a keyless coupling eliminates notches, grooves or slots that are formed in a shaft to receive the key, the strength and durability of the shaft may be improved leading to fewer broken shafts, less frequent maintenance of pumps, and lower costs associated with the ability to use smaller and less expensive components. The centrifugal pump described herein may be a downhole centrifugal pump or may instead be a horizontal pumping system (HPS) that is used in surface applications.

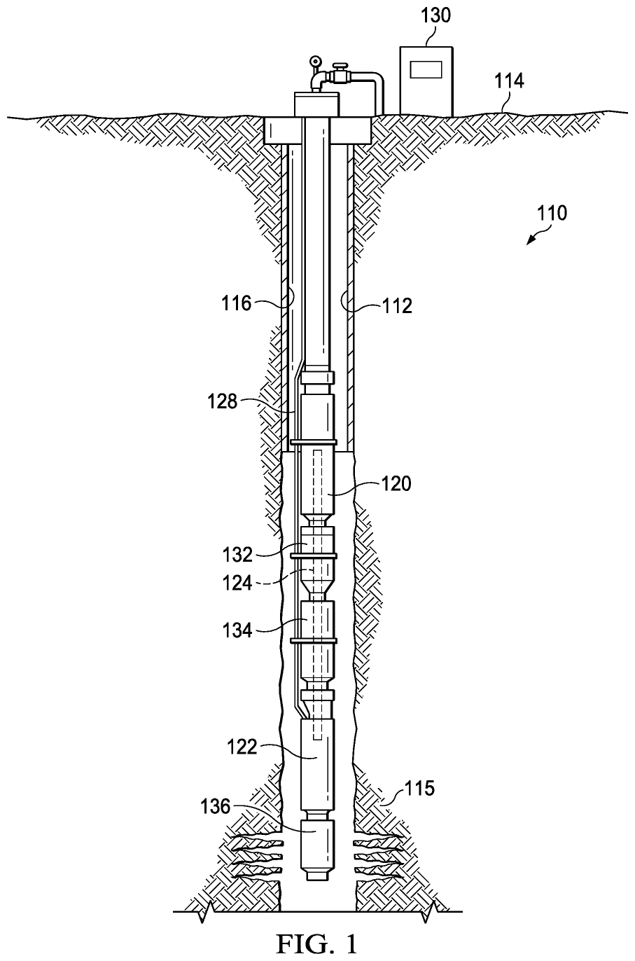

A wellbore pump system 110 in accordance with an illustrative embodiment of the present disclosure is illustrated in FIG. 1. The pump system 110 is deployed in a wellbore 112 extending from a surface location 114 of the well into a geologic formation 115. In the illustrated embodiment, the wellbore 112 extends from a terrestrial or land-based surface location. In other embodiments, the pump system 110 may be deployed in wellbores extending from offshore or subsea surface locations using offshore platforms, drill ships, semi-submersibles or drilling barges. The wellbore 112 defines an “uphole” direction referring to a portion of wellbore 112 that is closer to the surface location 114 and a “downhole” direction referring to a portion of wellbore 112 that is further from the surface location 114.

Wellbore 112 is illustrated in a generally vertical orientation. In other embodiments, the wellbore 112 may include portions in alternate deviated orientations such as horizontal, slanted or curved without departing from the scope of the present disclosure. Wellbore 112 optionally includes a casing string 116 therein, which extends generally from the surface location 114 to a selected downhole depth. Portions of the wellbore 112 that do not include casing string 116 may be described as “open hole.”

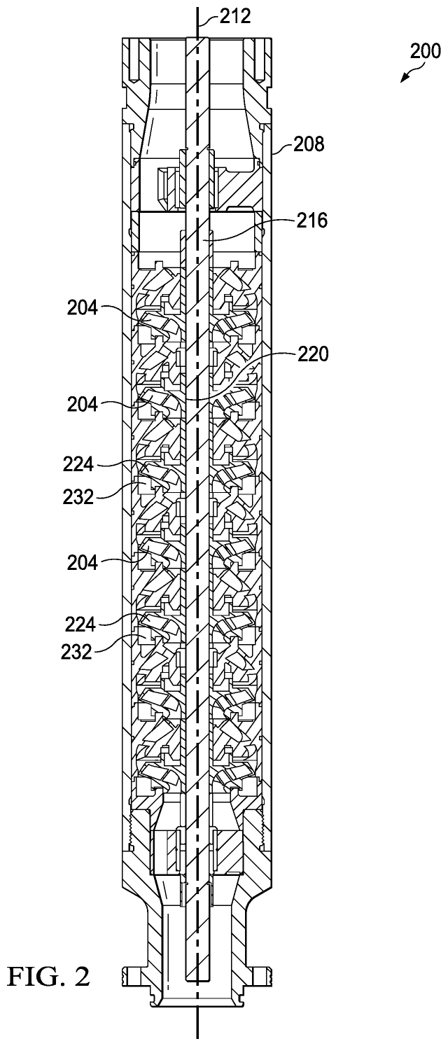

Various types of downhole hydrocarbon fluids may be pumped to the surface location 114 by a downhole pump 120 deployed in the wellbore 112. The pump 120 may be a multi-stage centrifugal pump that functions to transfer pressure to the hydrocarbon fluids (and/or other wellbore fluids present) to propel the fluids in the wellbore 112 to the surface location 114 at a desired pumping rate. The pump 120 may have any suitable size or construction based on parameters such as wellbore size, desired pumping rate, or fluid viscosity. The pump 120 may operate by adding kinetic energy to the hydrocarbon fluids via centrifugal force, and convert the kinetic energy to potential energy in the form of pressure using one or more impellers and diffusers as discussed below in greater detail with reference to FIG. 2.

The pump system 110 includes a motor 122 for driving the one or more impellers in the pump 120. A drive shaft 124 may operably connect the motor 122 to the impellers to transmit the rotational power of the motor 122 to the impellers located in the pump 120 and thereby cause the impellers to rotate. The motor 122 may also be coupled by a cable 128 to a controller 130 at the surface location 114, which may provide instructions to the motor 122 for operating in a particular manner. In other embodiments, a controller may be disposed at a downhole location.

Other various components of pump system 110 may include an intake 132, seal chamber 134, and sensor package 136. The intake 132 may allow fluid to enter the bottom of the pump 120 and flow to the first stage of the pump 120. Seal chamber 134 may extend the life of the motor 122 by protecting the motor 122 from contamination, and providing pressure equalization between the motor 122 and the wellbore 112.

The motor 122 may operate at high rotational speeds, such as 3,500 revolutions per minute, to thereby drive the rotation of the impellers in the pump 120. Rotation of the impellers may cause the pump 120 to pump fluid to the surface location 114. The sensor package 136 may include one or more sensors used to monitor the operating parameters of the pump 120 and/or conditions in the wellbore 112, such as the intake pressure, casing annulus pressure, internal motor temperature, pump discharge pressure and temperature, downhole flow rate, or equipment vibration. The sensor package 136 may be communicatively coupled to the controller 130.

Referring to FIG. 2, a cross-sectional schematic view of a multi-stage downhole centrifugal pump 200 is illustrated according to an illustrative embodiment. The centrifugal pump 200 includes a plurality of impellers 204 that are disposed within an elongated housing 208. The elongated housing 208 generally includes a longitudinal axis 212 along which is positioned a rotatable shaft 216. Each of the impellers 204 includes a central bore 220 that receives the rotatable shaft 216. The shaft 216 may be of solid or tubular construction and extends in a single piece along substantially the entire length of the elongated housing 208. The shaft 216 and impellers 204 are configured to rotate together such that power and rotation transmitted to the shaft 216 by a motor (not shown) is similarly imparted to the impellers 204. As each impeller 204 rotates within a diffuser 232 positioned in the housing 208, vanes 224 on each impeller move and pressurize fluid from a low-pressure side of each impeller 204 to a high-pressure side of each impeller 204. The diffuser 232 may be disposed within the elongated housing on the high-pressure side of each impeller 204 to direct fluid from one impeller to the next. Each impeller 204 and diffuser 232 combination is considered a single stage, and each stage of the pump 200 is fluidly connected to the next stage. The combination of multiple impellers and diffusers provides the multi-stage characteristics of the pump 200. Each stage progressively increases the pressure of fluid moving through the housing 208. All of the impellers 204 of the multi-stage pump 200 of FIG. 2 are capable of being rotated by rotating shaft 216.

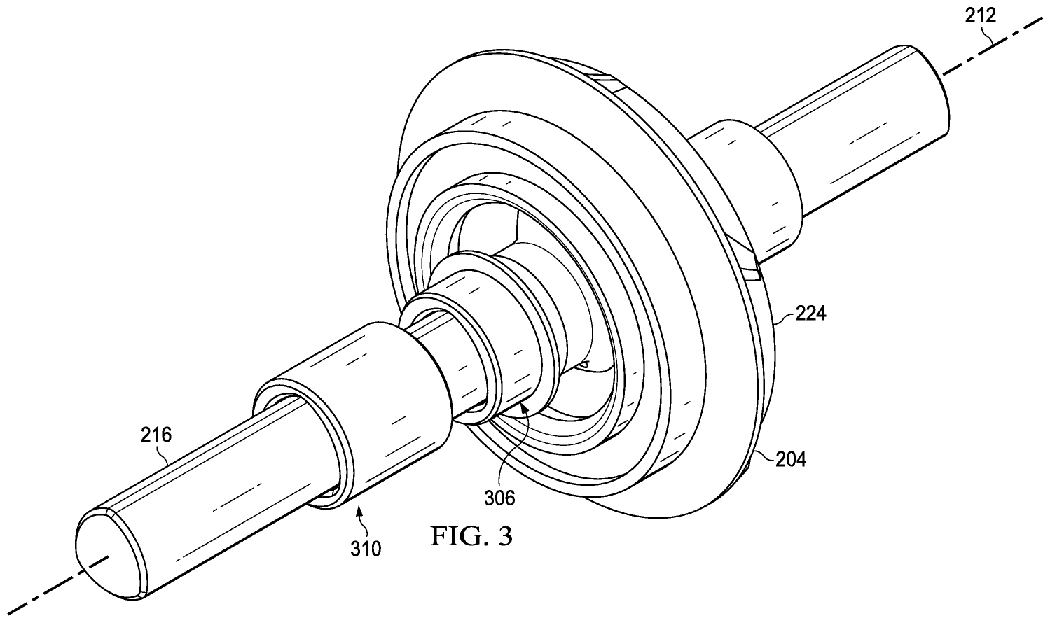

Referring to FIG. 3, an isometric view of impeller 204 and shaft 216 of pump 200 are illustrated. FIG. 3 represents a single impeller 204 of the pump 200. While the pump 200 described herein is illustrated as a multi-stage pump, it is important to note that the present disclosure is equally applicable to single stage pumps. In an embodiment, each stage of a multi-stage pump includes the impeller 204 and the diffuser 232 within which the impeller 204 is capable of rotating. The one or more stages of the pump 200 may further include a bearing sleeve 306 that serves as a bearing between the shaft 216 and the housing 208. A spacer sleeve 310 may also be provided between successive pump stages to space apart the impellers 204. Both the bearing sleeve 306 and the spacer sleeve 310 include central bores that are capable of receiving the shaft 216 and are similar in size and cross-sectional shape to the size and cross-sectional shape of the shaft 216.

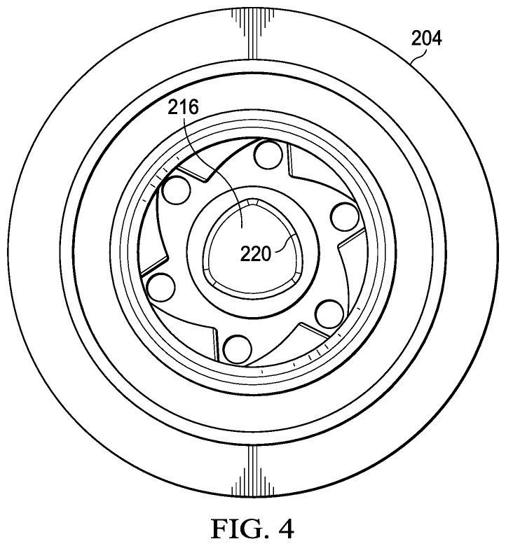

Referring to FIG. 4, a front view of the impeller 204 and shaft 216 are illustrated. FIG. 4 shows a cross-sectional shape of the shaft 216 in a plane normal to the longitudinal axis 212 (see FIG. 3). The cross-section of the shaft 216 is non-circular and closely matches a similar non-circular cross-sectional shape of the central bore 220 of the impeller 216. The complimentary non-circular cross-sections permit power transmission between the shaft 216 and the impeller 204 without the use of keys, slots, notches or keyways.

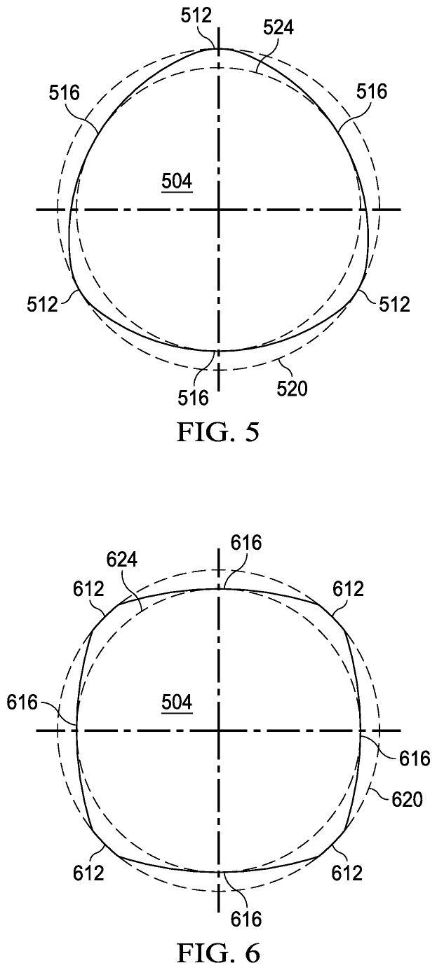

Referring to FIG. 5, a cross-sectional view of a shaft 504 having a polygonal profile is illustrated according to an illustrative embodiment. The shaft 504 is similar in shape to the non-circular shape of the shaft 216 illustrated in FIG. 3 and includes a plurality of lobes 512. More specifically, the shaft 504 includes three lobes 512, each lobe 512 being disposed about 120 degrees from an adjacent lobe 512. The shaft 504 further comprises three flats 516, each flat 516 disposed about 120 degrees from an adjacent flat 516 and positioned between two of the three lobes 512. The arrangement of the lobes 512 and flats 516 is such that a first circle 520 that circumscribes the lobes 512 is concentric to a second circle 524 that circumscribes the flats 516.

While the polygonal, non-circular profile described in FIG. 5 is associated with the shaft of the pump, the profile of the central bores of components through which the shaft passes is similar in profile and size such that the shaft is received within the particular component (e.g., impeller, bearing sleeve, spacer sleeve) in a complimentary fashion that allows power transmission between the shaft and the component.

Referring to FIG. 6, a cross-sectional view of a shaft 604 having a polygonal profile is illustrated according to an illustrative embodiment. The shaft 604, like the shaft 216, is also non-circular in shape and includes a plurality of lobes 612. More specifically, the shaft 604 includes four lobes 612, each lobe 612 being disposed about 90 degrees from an adjacent lobe 612. The shaft 604 further comprises four flats 616, each flat 616 disposed about 90 degrees from an adjacent flat 616 and positioned between two of the lobes 612. The arrangement of the lobes 612 and flats 616 is such that a first circle 620 that circumscribes the lobes 612 is concentric to a second circle 624 that circumscribes the flats 616.

While the polygonal, non-circular profile described in FIG. 6 is associated with the shaft of the pump, the profile of the central bores of components through which the shaft passes is similar in profile and size such that the shaft is received within the particular component (e.g., impeller, bearing sleeve, spacer sleeve) in a complimentary fashion that allows power transmission between the shaft and the component.

The three- and four-lobed shafts 504, 604 illustrated in FIGS. 5 and 6 are examples of non-circular cross-sections that may be used to transmit power to the impellers of the pump. Other non-circular cross-sections are possible, including cross-sections that include two lobed configurations or configurations with more than four lobes. In an embodiment, the configuration of the cross-section is such that rotation of the shaft is balanced and does not create excessive vibration.

In operation, the single or multi-stage pumps described herein may be operated by rotating the shaft with a motor. The shaft, including a non-circular or polygonal cross-section normal to an axis about which the shaft rotates, is received by one or more impellers of the pump and other components associated with the pump such as bearings, bearing sleeves and spacer sleeve. Each impeller or component includes a central bore through which the shaft passes, and the cross-section of each central bore is also non-circular and similar in shape to that of the shaft. The mating engagement between the shaft and the impeller (or any other components) allows power carried by the shaft to be transmitted to the impeller or other component without the provision of keys, keyways, slots or notches in the shaft, impeller or component. Similarly, the motor that provides rotational power to the shaft may also have a central bore or coupling that is sized and shaped to matingly engage the non-circular cross-section of the shaft, thereby eliminating keys and keyways at the motor coupling as well. Alternatively, the shaft may include one or more splines on an end of the shaft for coupling to the motor.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a downhole centrifugal pump comprising: a motor; an impeller; and a shaft having a longitudinal axis and a non-circular cross section in a plane perpendicular to the longitudinal axis, the shaft connected to the motor and the impeller such that rotational power provided by the motor to the shaft is provided to the impeller.

Clause 2, the downhole centrifugal pump of clause 1, wherein the non-circular cross-section of the shaft is polygonal.

Clause 3, the downhole centrifugal pump of clauses 1 or 2, wherein the non-circular cross-section of the shaft further comprises a plurality of lobes.

Clause 4, the downhole centrifugal pump of any of clauses 1-3, wherein the non-circular cross-section of the shaft further comprises three lobes, each lobe being disposed about 120 degrees from an adjacent lobe.

Clause 5, the downhole centrifugal pump of clause 4, wherein the non-circular cross-section of the shaft further comprises three flats, each flat disposed about 120 degrees from an adjacent flat and positioned two of the three lobes.

Clause 6, the downhole centrifugal pump of claim 5, wherein a first circle that circumscribes the lobes is concentric to a second a circle that circumscribes the flats.

Clause 7, the downhole centrifugal pump of any of clauses 1-3, wherein the non-circular cross-section of the shaft further comprises four lobes, each lobe being disposed about 90 degrees from an adjacent lobe.

Clause 8, the downhole centrifugal pump of any of clauses 1-7, wherein the connection of the shaft to the impeller is keyless.

Clause 9, the downhole centrifugal pump of any of clauses 1-8, wherein the connection of the shaft to the motor is keyless.

Clause 10, a multi-stage downhole centrifugal pump comprising: a motor; a first stage impeller having a first central bore aligned along a longitudinal axis of the pump, the central bore having a non-circular cross section in a plane perpendicular to the longitudinal axis; a second stage impeller having a having a second central bore aligned along the longitudinal axis, the second central bore having a non-circular cross section in a plane perpendicular to the longitudinal axis; and a shaft coupled to the motor and received by the first central bore of the first stage impeller and the second central bore of the second stage impeller, the shaft having a non-circular cross section in a plane perpendicular to the longitudinal axis.

Clause 11, the downhole centrifugal pump of clause 10, wherein the non-circular cross-sections of the first central bore, the second central bore and the shaft are the same shape.

Clause 12, the downhole centrifugal pump of clauses 10 or 11, wherein the non-circular cross-sections of the first central bore, the second central bore and the shaft are polygonal.

Clause 13, the downhole centrifugal pump of any of clauses 10-12, wherein the non-circular cross-section of the shaft further comprises a plurality of lobes.

Clause 14, the downhole centrifugal pump of any of clauses 10-13, wherein the non-circular cross-section of the shaft further comprises three lobes, each lobe being disposed about 120 degrees from an adjacent lobe.

Clause 15, the downhole centrifugal pump of clause 14, wherein the non-circular cross-section of the shaft further comprises three flats, each flat disposed about 120 degrees from an adjacent flat and positioned two of the three lobes.

Clause 16, the downhole centrifugal pump of any of clauses 10-15, wherein the coupling of the shaft to the first stage impeller and the second stage impeller is keyless.

Clause 17, the downhole centrifugal pump of any of clauses 10-16, wherein the coupling of the shaft to the motor is keyless.

Clause 18, the downhole centrifugal pump of any of clauses 10-17 further comprising: at least one additional impeller having a central bore aligned along the longitudinal axis, wherein the at least one additional impeller is disposed on the shaft such that the shaft is received by the central bore of the at least one additional impeller.

Clause 19, a method of removing fluid from a wellbore comprising: rotating about a longitudinal axis a shaft having a non-circular cross-section to turn one or more impellers within a pump housing; wherein the shaft is received by a central bore of the one or more impellers, the central bore having a non-circular cross-section.

Clause 20, the method of clause 19, wherein the non-circular cross-sections of the central bore and the shaft are polygonal.

While this specification provides specific details related to certain components of a downhole centrifugal pump and method, it may be appreciated that the list of components is illustrative only and is not intended to be exhaustive or limited to the forms disclosed. Other components related to downhole pumps within a wellbore will be apparent to those of ordinary skill in the art without departing from the scope and spirit of the disclosure. Further, the scope of the claims is intended to broadly cover the disclosed components and any such components that are apparent to those of ordinary skill in the art.

It should be apparent from the foregoing disclosure of illustrative embodiments that significant advantages have been provided. The illustrative embodiments are not limited solely to the descriptions and illustrations included herein and are instead capable of various changes and modifications without departing from the spirit of the disclosure.

We claim:

1. A downhole centrifugal pump comprising:
a motor;
an impeller; and
a shaft having a longitudinal axis and a non-circular cross section in a plane perpendicular to the longitudinal axis, the shaft connected to the motor and the impeller such that rotational power provided by the motor to the shaft is provided to the impeller.

2. The downhole centrifugal pump of claim 1, wherein the non-circular cross-section of the shaft is polygonal.

3. The downhole centrifugal pump of claim 1, wherein the non-circular cross-section of the shaft further comprises a plurality of lobes.

4. The downhole centrifugal pump of claim 1, wherein the non-circular cross-section of the shaft further comprises three lobes, each lobe being disposed about 120 degrees from an adjacent lobe.

5. The downhole centrifugal pump of claim 4, wherein the non-circular cross-section of the shaft further comprises three flats, each flat disposed about 120 degrees from an adjacent flat and positioned two of the three lobes.

6. The downhole centrifugal pump of claim 5, wherein a first circle that circumscribes the lobes is concentric to a second a circle that circumscribes the flats.

7. The downhole centrifugal pump of claim 1, wherein the non-circular cross-section of the shaft further comprises four lobes, each lobe being disposed about 90 degrees from an adjacent lobe.

8. The downhole centrifugal pump of claim 1, wherein the connection of the shaft to the impeller is keyless.

9. The downhole centrifugal pump of claim 1, wherein the connection of the shaft to the motor is keyless.

10. A multi-stage downhole centrifugal pump comprising:
a motor;
a first stage impeller having a first central bore aligned along a longitudinal axis of the pump, the central bore having a non-circular cross section in a plane perpendicular to the longitudinal axis;
a second stage impeller having a having a second central bore aligned along the longitudinal axis, the second central bore having a non-circular cross section in a plane perpendicular to the longitudinal axis; and
a shaft coupled to the motor and received by the first central bore of the first stage impeller and the second central bore of the second stage impeller, the shaft having a non-circular cross section in a plane perpendicular to the longitudinal axis.

11. The downhole centrifugal pump of claim 10, wherein the non-circular cross-sections of the first central bore, the second central bore and the shaft are the same shape.

12. The downhole centrifugal pump of claim 10, wherein the non-circular cross-sections of the first central bore, the second central bore and the shaft are polygonal.

13. The downhole centrifugal pump of claim 10, wherein the non-circular cross-section of the shaft further comprises a plurality of lobes.

14. The downhole centrifugal pump of claim 10, wherein the non-circular cross-section of the shaft further comprises three lobes, each lobe being disposed about 120 degrees from an adjacent lobe.

15. The downhole centrifugal pump of claim 14, wherein the non-circular cross-section of the shaft further comprises three flats, each flat disposed about 120 degrees from an adjacent flat and positioned two of the three lobes.

16. The downhole centrifugal pump of claim 10, wherein the coupling of the shaft to the first stage impeller and the second stage impeller is keyless.

17. The downhole centrifugal pump of claim 10, wherein the coupling of the shaft to the motor is keyless.

18. The downhole centrifugal pump of claim 10 further comprising:
at least one additional impeller having a central bore aligned along the longitudinal axis,
wherein the at least one additional impeller is disposed on the shaft such that the shaft is received by the central bore of the at least one additional impeller.

19. A method of removing fluid from a wellbore comprising:
rotating about a longitudinal axis a shaft having a non-circular cross-section to turn one or more impellers within a pump housing;
wherein the shaft is received by a central bore of the one or more impellers, the central bore having a non-circular cross-section.

20. The method of claim 19, wherein the non-circular cross-sections of the central bore and the shaft are polygonal.
